(19) United States
(12) Patent Application Publication
(10) Pub. No.: US 2012/0250123 A1
(43) Pub. Date: Oct. 4, 2012

(54) APPARATUS AND METHOD FOR EVALUATING HOLOGRAM IMAGE RECORDING MEDIUM

(75) Inventors: Naoki HAYASHIDA, Tokyo (JP); Jiro YOSHINARI, Tokyo (JP); Shohei FUJII, Tokyo (JP); Kazushi TANAKA, Tokyo (JP)

(73) Assignee: TDK CORPORATION, Tokyo (JP)

(21) Appl. No.: 13/361,352

(22) Filed: Jan. 30, 2012

(30) Foreign Application Priority Data
Mar. 31, 2011 (JP) 2011-077065

(51) Int. Cl. G03H 1/26

(52) U.S. Cl. 359/22

(57) ABSTRACT

A method for evaluating a hologram image recording medium includes: recording continuously a plurality of fine holograms, each being the same in size as an element hologram, on a hologram image recording medium to be evaluated, using either one of a two-beam interference between a reference beam and a signal beam both being a plane wave and a two-beam interference between a reference beam being a plane wave and a signal beam being a spherical wave; reproducing a diffraction image by irradiating the recorded fine hologram with a plane wave; from intensity distribution data based on a captured diffraction image, determining an intensity distribution data array and a diffracted beam intensity Iₛ, the intensity distribution data array having the same shape and size as those of the fine hologram; and when the diffracted beam intensity Iₛ takes on the maximum value Iₛ(ₘₐₓ), determining an SN ratio.

### TECHNICAL FIELD

The present invention relates to an apparatus and a method for evaluating a hologram image recording medium.

### BACKGROUND ART

As a method for recording stereoscopic images using holograms, there is known a method for continuously recording rectangular or circular element holograms having a magnitude of several hundreds of μm on a hologram image recording medium to obtain a holographic stereogram.

This is generally referred to as a holographic 3D printer or the like, which is configured such that the intensity pattern of a group of light beams to be read from each element hologram is computed on a computer and the computed results are output to a spatial light modulator (SLM) to record a hologram.

For this hologram, even an non-existent object, for example, a stereoscopic image formed by computer graphics can be stereoscopically recorded via a personal computer or the like in much the same way a printer is used to print conventional two-dimensional images.

Like the conventional Lippmann hologram or the like, a silver halide photosensitive material or a photopolymer is used as a recording medium for the aforementioned holographic stereogram. In particular, typical photopolymer (photosensitive resin) does not require the wet development unlike the silver halide photosensitive material and is thus suited for practical use.

The performance indicator used for the recording medium mentioned above is a diffraction efficiency η which is typically defined by Id/Ir or Id/(Id+I₀), where Ir is the intensity of a reference beam, Id is the intensity of a diffracted beam (read beam), and I₀ is the intensity of the 0th order beam (transmitted beam).

The diffraction efficiency η indicates the rate of use of a reference beam as a diffracted beam, the reference beam being employed to irradiate and reproduce a recorded hologram, and a recording medium having a higher diffraction efficiency is regarded to be superior.

On the other hand, in the case of practical recording of image information as a Lippmann hologram or a holographic stereogram, not only the diffraction efficiency η but also the contrast (SN ratio) or blurring of a recorded image becomes critical. Methods for measuring such a performance indicator have been suggested, for example, as disclosed in Japanese Patent Application Laid-Open No. Hei. 05-196542, Japanese Patent Publication No. 3058929, Japanese Patent Publication No. 3072909, and Japanese Patent Publication No. 3344553.

However, these methods for measuring a performance indicator are all intended for the Lippmann hologram and holographic optical devices, and can be referred to as a static method for measuring performance indicators.

In contrast to this, the holographic 3D printer is configured to continuously record element holograms of several hundreds of μm in size with pitches generally equal to the size of the element holograms, in the case of which such continuous recording may cause adjacent element holograms to affect mutual image qualities.

Accordingly, those recording media or recording conditions which are determined to have good properties by the aforementioned static method for measuring performance indicators may not necessarily allow the holographic 3D printer to provide a good image quality.

That is, there has been conventionally no property evaluation method for adequately evaluating storage media or recording conditions which are suitable for continuous recording or dynamic recording of element holograms

### SUMMARY OF INVENTION

### Technical Problem

In view of the foregoing problems, various exemplary embodiments of this invention provide, as a performance evaluation method on which the dynamic recording as with the holographic 3D printer is reflected, an apparatus and a method for evaluating a hologram image recording medium for recording image information by continuously recording element holograms in a two-dimensional manner.

### Solution to Problem

As a result of intensive studies, the inventors have found that in order to evaluate the continuous recording of element holograms, that is, by simulating dynamic recording, holograms (fine holograms) each being the same in size as the element hologram are continuously recorded to quantitatively measure the properties of the diffraction images of the fine holograms, facilitating the evaluation of a hologram image recording medium.

In summary, the above-described objectives are achieved by the following embodiments of the present invention.

(1) A method for evaluating a hologram image recording medium for recording image information by continuously recording element holograms in a two-dimensional manner, the method comprising: a step of continuously recording a plurality of fine holograms, each being the same in size as the element hologram, on a hologram image recording medium to be evaluated, using either one of a two-beam interference between a reference beam and a signal beam both being a plane wave and a two-beam interference between a reference beam being a plane wave and a signal beam being a spherical wave; a step of reproducing a diffraction image by irradiating the recorded fine hologram with a plane wave, the plane wave having the same wavelength, the same beam diameter, and the same incident angle as those of one of the reference beam used for recording by the two-beam interference and a conjugate image read beam; a step of capturing the reproduced diffraction image by an image pickup device which is greater in area than the fine hologram; a step of converting the captured diffraction image into intensity distribution data to extract an intensity distribution data array fₛ(x, y) which is equivalent in a range of shape and size to the fine hologram on a light-receiving surface of the image pickup device and then calculate a diffracted beam intensity Iₛ=Σfₛ(x, y) defined by a sum total of the extracted intensity distribution data arrays fₛ(x, y); one of a step of calculating an SN ratio as an evaluation value for the hologram image recording medium, a step of calculating a relative diffraction efficiency η₀ as an evaluation value for the hologram image recording medium, and a step of calculating a diffraction efficiency η as an evaluation value for the hologram image recording medium.

(2) The method for evaluating a hologram image recording medium according to (1), wherein when the diffracted beam intensity Iₛ takes on a maximum value I_{s (max)}, the step of calculating an SN ratio determines a noise beam intensity Iₙ=Σfₙ(x, y) defined by a sum total of values of data arrays fₙ(x, y), which take a predetermined slice level I_{threshold} or greater, among data arrays f(x, y) which have not been extracted as the fₛ(x, y), and determines an SN ratio=I_{s (max)}/Iₙ.

(3) The method for evaluating a hologram image recording medium according to (1), wherein when the diffracted beam intensity Iₛ takes on the maximum value I_{s (max)}, the step of calculating a relative diffraction efficiency η₀ as an evaluation value for the hologram image recording medium determines η₀=Iₛ/(f_{s (max)} (x, y)×Sₕₒₗₒ/Sₚᵢₓ) where the f_{s (max)} (x, y) is the maximum value of data arrays f(x, y) extracted as the fₛ(x, y), Sₕₒₗₒ is an area of the fine hologram region, and Sₚᵢₓ is a pixel area of the image pickup device.

(4) The method for evaluating a hologram image recording medium according to (1), wherein when the diffracted beam intensity Is takes on the maximum value I_{s (max)}, the step of calculating a diffraction efficiency η as an evaluation value for the hologram image recording medium determines η=Iₛ/I_{R}, where I_{R} is an intensity of a plane wave used for reading the fine hologram.

(5) The method for evaluating a hologram image recording medium according to any one of (1) to (4), wherein the plane wave in the recording step is not modulated.

(6) The method for evaluating a hologram image recording medium according to any one of (1) to (5), wherein for the plurality of recorded fine holograms, a step of sequentially capturing reproduced diffraction images, a step of extracting an intensity distribution data array fₛ(x, y), and a step of determining an evaluation value are repeated.

(7) The method for evaluating a hologram image recording medium according to any one of (1) to (6), wherein when a plurality of fine holograms are continuously recorded by two-beam interference on a hologram image recording medium, a size “a” of the fine hologram in a direction of the continuous recording is equal to or less than a pitch “d” of the continuous recording.

(8) The method for evaluating a hologram image recording medium according to any one of (1) to (7), wherein an image pitch “p” of the image pickup device is equal to or less than ¼ the size “a” of the fine hologram.

(9) An apparatus for evaluating a hologram image recording medium for recording image information by continuously recording element holograms in a two-dimensional manner, the apparatus comprising: a recording optical system for continuously recording a plurality of fine holograms, each being the same in size as the element hologram, on a hologram image recording medium to be evaluated, using either one of a two-beam interference between a reference beam and a signal beam both being a plane wave and a two-beam interference between a reference beam being a plane wave and a signal beam being a spherical wave; a reading optical system for reproducing a diffraction image by irradiating the recorded fine hologram with a plane wave, the plane wave having the same wavelength, the same beam diameter, and the same incident angle as those of one of the reference beam used for recording by the two-beam interference and a conjugate image read beam; an image pickup optical system for capturing the reproduced diffraction image on an image pickup device which is greater in area than the fine hologram; a diffracted beam intensity computing device for converting the captured diffraction image into intensity distribution data to extract an intensity distribution data array fₛ(x, y) which is equivalent in the range of shape and size to the fine hologram on a light-receiving surface of the image pickup device and then calculate a diffracted beam intensity Iₛ=Σfₛ(x, y) defined by a sum total of values thereof; an SN ratio computing device for determining an SN ratio as an evaluation value for the hologram image recording medium; a relative diffraction efficiency computing device for determining a relative diffraction efficiency η₀ as an evaluation value for the hologram image recording medium; and a diffraction efficiency computing device for determining a diffraction efficiency η as an evaluation value for the hologram image recording medium, wherein the SN ratio computing device has a noise beam intensity computing device for determining a noise beam intensity Iₙ=Σfₙ(x, y) defined by a sum total of values of data arrays fₙ(x, y), which take a predetermined slice level I_{threshold} or greater, among data arrays f(x, y) which have not been extracted as the fₛ(x, y), when the diffracted beam intensity Iₛ takes on a maximum value I_{s (max)}, and an SN ratio calculator for calculating an SN ratio=I_{s (max)}/Iₙ as an evaluation value for the hologram image recording medium, when the diffracted beam intensity Iₛ takes on the maximum value I_{s (max)}, the relative diffraction efficiency computing device is configured to calculate a relative diffraction efficiency η₀ as an evaluation value for the hologram image recording medium by Equation (1) below

η₀=Iₛ/(f_{s (max)}(x, y)×Sₕₒₗₒ/Sₚᵢₓ) (Equation 1)

where the f_{s (max)} (x, y) is the maximum value of data arrays f(x, y) extracted as the fₛ(x, y), Sₕₒₗₒ is an area of the fine hologram region, and Sₚᵢₓ is a pixel area of the image pickup device, and when the diffracted beam intensity Iₛ takes on the maximum value I_{s (max)}, the diffraction efficiency computing device is configured to determine the diffraction efficiency η as an evaluation value for the hologram image recording medium by Equation (2) below;

η=Iₛ/I_{R} (Equation 2)

where I_{R} is an intensity of a plane wave used for reading the fine hologram.

(10) The apparatus for evaluating a hologram image recording medium according to (9), further comprising: an area comparator for comparing an area of a diffraction image captured by the image pickup device with an area of the fine hologram to output a signal indicating magnified when the area of the diffraction image is equal to or greater than the area of the fine hologram, and output a signal indicating contracted when the area of the diffraction image is less than the area of the fine hologram; and a switching device for connecting the diffracted beam intensity computing device to the SN ratio computing device when the output signal from the area comparator is the signal indicating magnified, and for connecting the diffracted beam intensity computing device to at least one of the relative diffraction efficiency computing device and the diffraction efficiency computing device when the output signal is the signal indicating contracted.

(11) The apparatus for evaluating a hologram image recording medium according to (10), wherein the plane wave in the recording optical system is not modulated.

### Advantageous Effects of Invention

The evaluation method and apparatus of the present invention make it possible to easily and accurately evaluate the hologram image storage media and recording conditions which are used with a holographic printer for recording stereoscopic image information by the continuous recording of fine element holograms.

### BRIEF DESCRIPTION OF DRAWINGS

FIG. 1 is a block diagram illustrating an apparatus for evaluating a hologram image recording medium according to an exemplary embodiment of the present invention;

FIG. 2 is a schematic optical system diagram illustrating a recording optical system in an apparatus for evaluating a hologram image recording medium according to an exemplary embodiment of the present invention;

FIG. 3 is a cross-sectional view schematically illustrating the recording optical system which is recording a fine hologram with a signal beam and a reference beam both being a plane wave;

FIG. 4 is a schematic optical system diagram illustrating a reading optical system of the apparatus for evaluating a hologram image recording medium according to the aforementioned exemplary embodiment;

FIG. 5 is a block diagram illustrating an evaluation value computing device in the apparatus for evaluating a hologram image recording medium according to the aforementioned exemplary embodiment;

FIG. 6 is a flowchart showing the steps of calculating an evaluation value according to the aforementioned exemplary embodiment;

FIG. 7 is a cross-sectional view schematically illustrating the reading optical system which is reading a hologram image with a reference beam being a plane wave;

FIG. 8 is a plan view schematically illustrating a status of a reproduced fine hologram image;

FIG. 9 is a plan view schematically illustrating the relationship between the status of a fine hologram image captured by an image pickup device and the unit pixels of the image pickup device; and

FIG. 10 is a plot showing the relationship between an evaluation value calculated in an example experiment and a hologram image.

### DESCRIPTION OF EMBODIMENTS

Now, exemplary embodiments of the present invention will be described below in more detail with reference to the accompanying drawings.

Note that as used herein, the term “element hologram” refers to a hologram which has the magnitude of one region which is targeted at when images are actually recorded on a hologram image recording medium. Image information is recorded on each element hologram, so that one hologram image is reproduced by all the element holograms.

### Embodiment

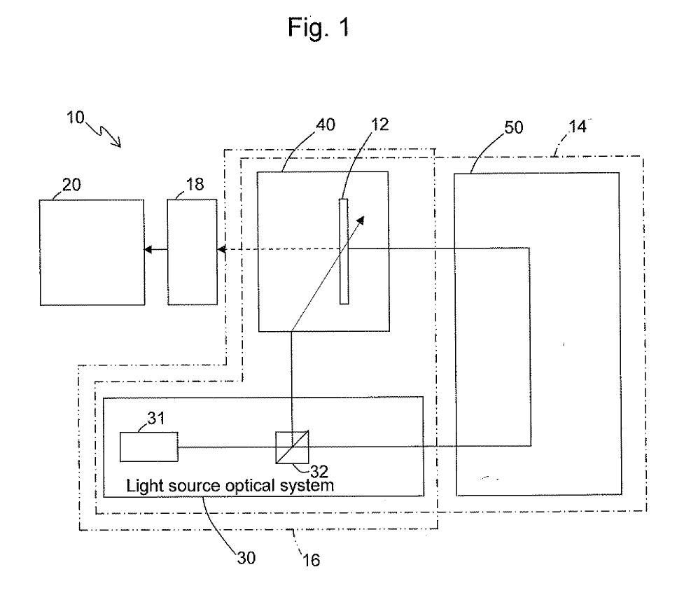

As shown in FIG. 1, a hologram image recording medium evaluation apparatus 10 according to an exemplary embodiment of the present invention is configured to include a recording optical system 14 for continuously recording a plurality of fine holograms, each being the same in size as an element hologram, on a hologram image recording medium 12 to be evaluated; a reading optical system 16 for reproducing a diffraction image by irradiating the recorded fine hologram with a plane-wave reference beam; an image pickup optical system 18 for capturing the reproduced diffraction image by an image pickup device which is greater in area than the fine hologram; and an evaluation value computing device 20 for determining an SN ratio as an evaluation value for the hologram image recording medium 12 on the basis of the diffraction image captured by the image pickup optical system 18.

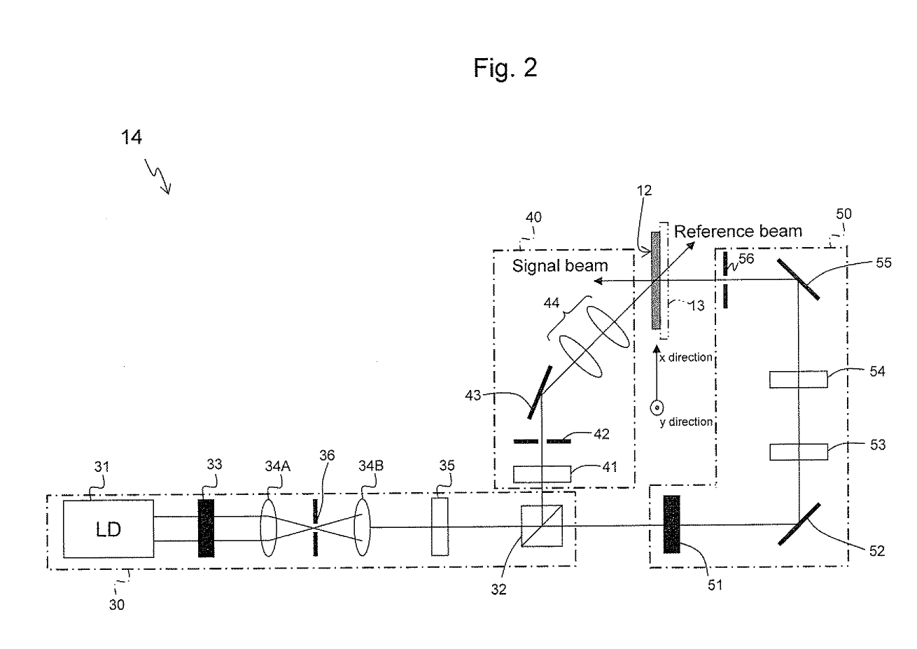

As shown in FIG. 2, the recording optical system 14 is configured to include a light source optical system 30 which has a laser diode 31 and a polarizing beam splitter 32 and which directs a laser beam from the laser diode 31 to the polarizing beam splitter 32; a reference beam optical system 40 for directing a reference beam separated by the polarizing beam splitter 32 to the hologram image recording medium 12;

and a signal beam optical system 50 for directing a signal beam separated by the polarizing beam splitter 32 to the hologram image recording medium 12.

Between the laser diode 31 and the polarizing beam splitter 32, the light source optical system 30 includes, from the laser diode 31 side, a first shutter 33, convex lenses 34A and 34B, a first half-wave plate 35, and a pin hole 36 between the convex lenses 34A and 34B at the focal position thereof.

Between the polarizing beam splitter 32 and the hologram image recording medium 12, the reference beam optical system 40 includes a first polarizing filter 41, a first aperture 42, a rotatable mirror 43, and relay lenses 44 in this order.

Between the polarizing beam splitter 32 and the hologram image recording medium 12, the signal beam optical system 50 includes a second shutter 51, a first fixed mirror 52, a second half-wave plate 53, a second polarizing filter 54, a second fixed mirror 55, and a second aperture 56 in this order.

The aforementioned recording optical system 14 is configured such that a laser beam emitted from the laser diode 31 is turned to a plane wave through the pair of convex lenses 34A and 34B and the pin hole 36 disposed therebetween; and the polarization plane of the linearly polarized beam is shifted by 90 degrees by the first half-wave plate 35 to further split this linearly polarized beam by the polarizing beam splitter 32 to two linearly polarized beams having planes of oscillation orthogonal to each other, allowing one to be directed to the reference beam optical system 40 and the other to be directed to the signal beam optical system 50.

In the reference beam optical system 40, the incident linearly polarized beam passes through the first polarizing filter 41 for noise components to be removed therefrom and is then provided with a fixed beam diameter through the first aperture 42, and thereafter reflected on the rotatable mirror 43 to be incident upon the hologram image recording medium 12 via the relay lenses 44.

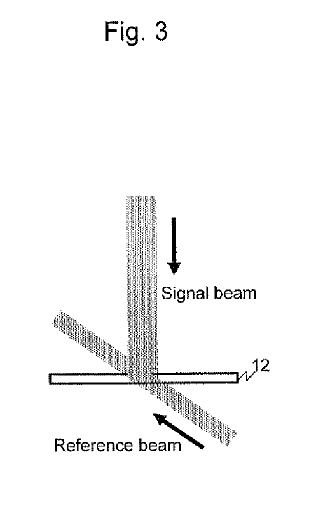

Furthermore, in the signal beam optical system 50, the incident linearly polarized beam passes through the second shutter 51 and the first fixed mirror 52 to be converted by the second half-wave plate 53 into a linearly polarized beam having the same plane of oscillation as that of the reference beam. The resulting linearly polarized beam passes through the second polarizing filter 54 for noise to be removed therefrom and is reflected on the second fixed mirror 55 to be provided with an adjusted beam diameter by the second aperture 56 and then incident upon the hologram image recording medium 12, where the beam interferes with the reference beam to record a fine hologram. This recording operation is shown in FIG. 3.

Here, the diameter of the first aperture 42 and the second aperture 56 is the one which the fine hologram being the same in size as the element hologram has when being formed on the hologram image recording medium 12.

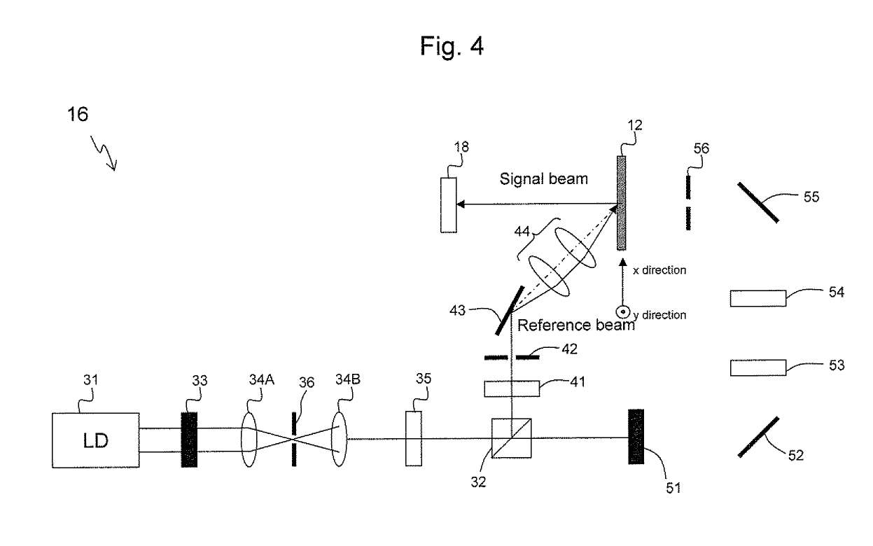

Now, a description will be made to the reading optical system 16 shown under magnification in FIG. 4.

The reading optical system 16 is the same as the light source optical system 30 and the reference beam optical system 40 in the recording optical system 14 shown in FIG. 2, in which like reference symbols are used to designate like structural elements shown in FIG. 2 without further explanation.

Furthermore, the image pickup optical system 18 is composed of image pickup devices such as CMOS or CCD for capturing a diffracted beam (read beam) which is formed when the hologram image recording medium 12 is irradiated with the reference beam for reading.

The reading optical system 16 employs the recording optical system 14. However, during readout of diffraction images, the second shutter 51 is closed so that no polarized light enters the signal beam optical system 50, and the rotatable mirror 43 is configured to adjust the incident angle of the reference beam to the hologram image recording medium 12 so that the diffraction image can be reproduced with the highest efficiency.

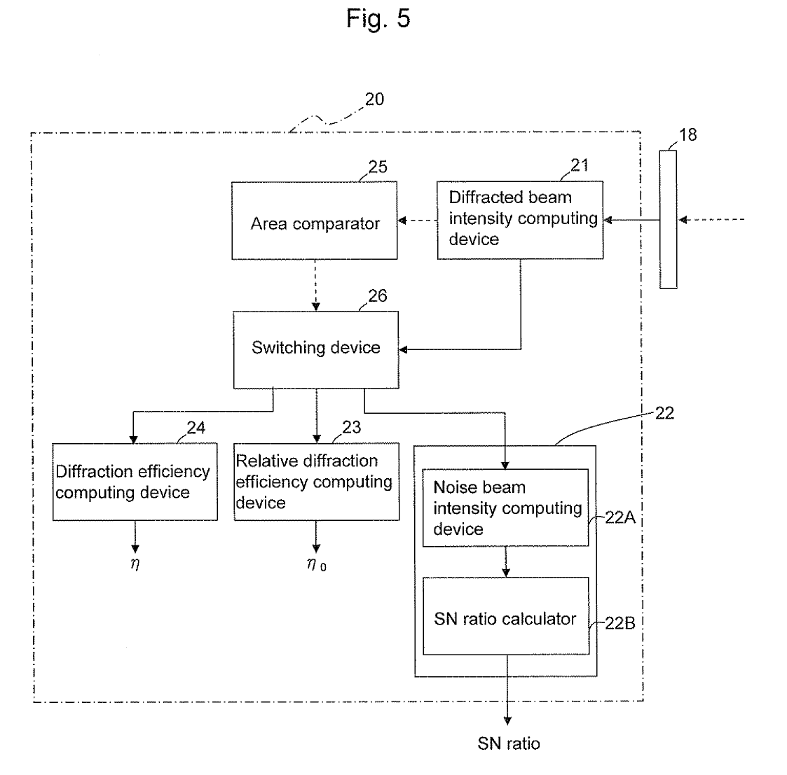

Now, with reference to FIG. 5, the evaluation value computing device 20 will be described below in detail.

The evaluation value computing device 20 is configured to include a diffracted beam intensity computing device 21, an SN ratio computing device 22, a relative diffraction efficiency computing device 23, a diffraction efficiency computing device 24, an area comparator 25, and a switching device 26.

The SN ratio computing device 22 is composed of a noise beam intensity computing device 22A and an SN ratio calculator 22B.

The diffracted beam intensity computing device 21 is configured to convert the diffraction image captured by the image pickup optical system 18 into intensity distribution data to extract an intensity distribution data array fₛ(x, y) of the same shape and the same size as those of the fine hologram, calculating a diffracted beam intensity Iₛ=Σfₛ(x, y) defined by a sum total of the values thereof.

When the diffracted beam intensity Iₛ takes on the maximum value I_{s (max)}, the noise beam intensity computing device 22A in the SN ratio computing device 22 is configured to determine a noise beam intensity Iₙ=Σfₙ(x, y) defined by a sum total of the values of the data arrays fₙ(x, y), which have a predetermined slice level I_{threshold} or greater, among those data arrays f(x, y) which have not been extracted as the fₛ(x, y). The SN ratio calculator 228 is configured to calculate an SN ratio=I_{s (max)}/Iₙ as an evaluation value for the hologram image recording medium.

The relative diffraction efficiency computing device 23 is configured to calculate a relative diffraction efficiency no as an evaluation value for the hologram image recording medium by Equation (1) below when the diffracted beam intensity Iₛ takes on the maximum value I_{s (max)}:

η₀=Iₛ/f_{s (max)}(x, y)×Sₕₒₗₒ/Sₚᵢₓ) (1)

where f_{s (max)} (x, y) is the maximum value of the data array f(x, y) extracted as the fₛ(x, y), Sₕₒₗₒ is the area of the fine hologram region, and Sₚᵢₓ is the pixel area of the image pickup device.

Furthermore, the diffraction efficiency computing device 24 is configured to calculate a diffraction efficiency η as an evaluation value for the hologram image recording medium by Equation (2) below when the diffracted beam intensity Iₛ takes on the maximum value I_{s (max)}:

η=Iₛ/I_{R} (2)

where I_{R} is the intensity of a plane wave used for reading the fine hologram.

The area comparator 25 is configured to compare the area of the diffraction image captured by the image pickup device with the area of the fine hologram so as to output a signal indicating magnified when the area of the diffraction image is equal to or greater than the area of the fine hologram and a signal indicating contracted when being less than the area of the fine hologram.

Furthermore, the area comparator 25 can be set at an arbitrary slice level and functions to calculate the sum total of the pixel areas, which have intensity data f(x, y) equal to or greater than the slice level, as a diffraction image area, which is then compared with the area of the fine hologram. The slice level can be set at an arbitrary value, for example, preferably at 20 to 80% of the maximum value f_{s (max)} (x, y) of the intensity data f(x, y).

The switching device 26 is configured to connect the diffracted beam intensity computing device 21 to the SN ratio computing device 22 when the output signal from the area comparator 25 is the signal indicating magnified, whereas connecting to at least one of the relative diffraction efficiency computing device 23 and the diffraction efficiency computing device 24 when the output signal is the signal indicating contracted.

That is, the evaluation value computing device 20 is configured to determine an SN ratio as an evaluation value for the hologram image recording medium by the SN ratio computing device 22 when the area of the diffraction image is equal to or greater than the area of the fine hologram, and to calculate the relative diffraction efficiency η₀ and/or the diffraction efficiency η as an evaluation value for the hologram image recording medium 12 when the area of the diffraction image is less than the area of the fine hologram.

Note that the area comparator 25 and the switching device 26 may not be necessarily included. In that case, irrespective of the magnitude of the diffraction image area, the evaluation apparatus 10 always calculates and outputs the SN ratio, the relative diffraction efficiency η₀ and/or the diffraction efficiency η.

The evaluation apparatus 10 is configured such that the hologram image recording medium 12 is disposed on an XY stage 13, so that the hologram image recording medium 12 which is plate shaped can be moved within the XY plane of FIG. 2.

In practice, the XY stage 13 is configured to move the hologram image recording medium 12 within the XY plane to sequentially change the position at which a fine hologram is formed, thereby allowing for continuously forming fine holograms on the hologram image recording medium 12 in a two-dimensional manner.

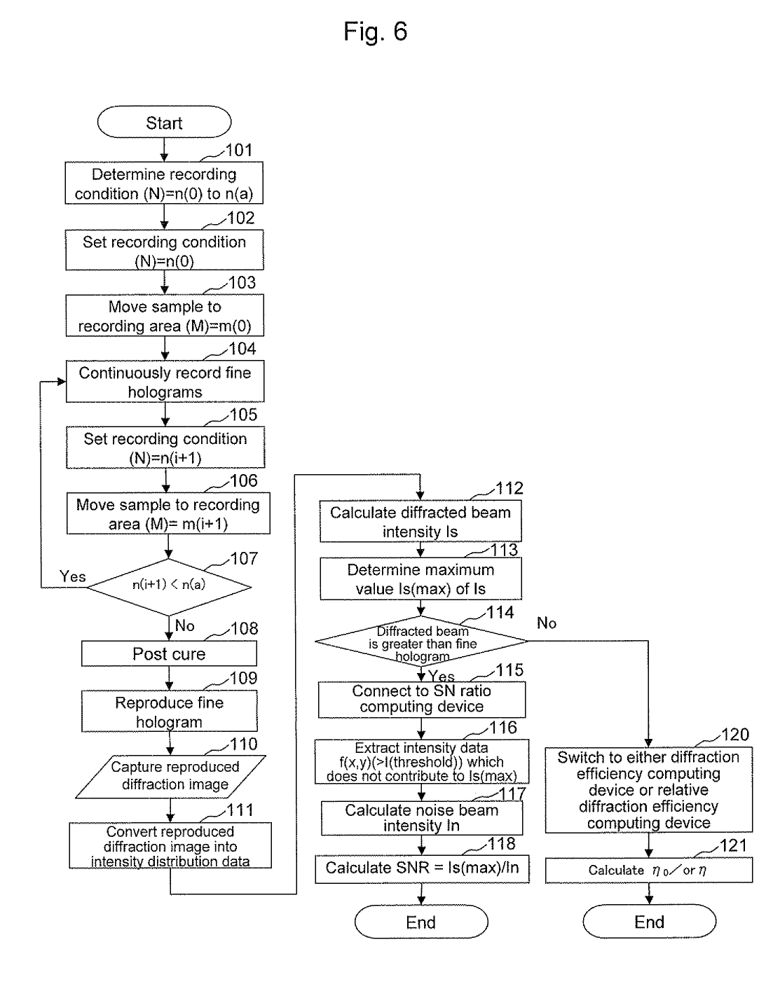

Now, referring to FIG. 6, a description will be made to the steps for continuously recording fine holograms on the hologram image recording medium 12 and then reproducing the fine holograms, thereby deriving the SN ratio, the relative diffraction efficiency η₀, or the diffraction efficiency η as an evaluation value for the hologram image recording medium.

Here, for (a+1) sets of recording conditions (N), fine holograms are continuously recorded on a hologram image recording medium under each set of recording conditions, and the continuously recorded fine hologram are reproduced.

First, in step 101, the recording conditions (N)=n(0) to n(a) are determined, and then in the next step 102, the first recording condition (N)=n(0) is set. In step 103, the sample (the hologram image recording medium to be evaluated) is moved to an m(0) recording area (M).

In step 104, as shown in FIG. 2, a laser beam is emitted from the laser diode 31 and split by the polarizing beam splitter 32 into two linearly polarized beams having planes of oscillation orthogonal to each other, and the separated beams are directed to the reference beam optical system 40 and the signal beam optical system 50, respectively. These beams are coherently interfered on the hologram image recording medium 12, whereby fine holograms are formed.

The fine holograms are continuously recorded by moving the hologram image recording medium. At this time, the number of fine holograms to be recorded is to be at least three.

Then, in the next step 105, the recording condition (N) is set to n(1) (here i=0, so that n(i+1)=n(1)), and then in step 106, the sample is moved to an m(1) recording area (M) (here i=0, so that m(i+1)=m(1)).

In the next step 107, it is determined whether n(i+1) is less than n(a). If positive, the process returns to step 104, where fine holograms are continuously recorded under that condition. Furthermore, recording conditions are set to sequentially perform continuous recording of fine holograms until n(i+1)=n(a), so that at n(i+1)=n(a), the process determines “negative” in step 107 and then proceeds to the next step 108 for post cure.

The post cure may require some hologram image recording medium to be heated and/or irradiated with ultraviolet (UV) radiation depending on the material for the medium. However, the UV radiation is preferably employed in order to complete the evaluation process within the evaluation apparatus of the present invention. This can be achieved, for example, by including a UV radiation device such as an ultraviolet LED at an appropriate position in the evaluation apparatus.

After the post cure, the process proceeds to step 109, where the reading optical system 16 of FIG. 4 reproduces the fine holograms.

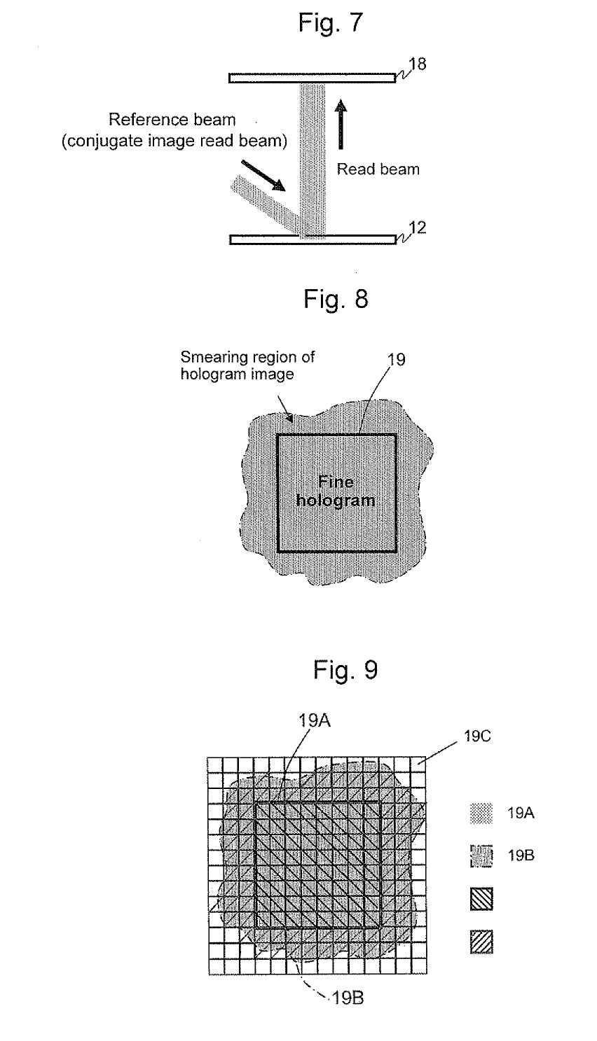

In this reproduction, the hologram image recording medium 12 is irradiated with a plane wave which has the same wavelength, the same beam diameter, and the same incident angle as those of one of the reference beam used for the recording and the conjugate image read beam to obtain a reproduced diffraction image which is emitted in the same direction as the signal beam of FIG. 2. This reproduction is schematically shown in FIG. 7.

Then, in step 110, the aforementioned reproduced diffraction image is captured by the image pickup optical system 18 which includes an image pickup device.

The image pickup optical system 18 is composed of a CMOS sensor, a CCD sensor or the like. As shown in FIGS. 8 and 9, a reading diffracted beam is greater than a signal beam region (fine hologram region) 19A that has a range equivalent to one fine hologram 19, and unit pixels 19C of the image pickup device are arrayed with pitch “p” in a two-dimensional manner over the range of a smearing region 195 surrounding the signal beam region 19A.

The aforementioned signal beam region 19A has the size of an image which is obtained by reproducing a fine hologram just enough without scaling and which is defined here as a square having a side “a.”

In general, it has been thought that reproducing a fine hologram would cause the reproduced diffraction image to have a smearing region or noise outside the intrinsic size of the fine hologram. However, the inventor has found that the magnitude of a reproduced diffraction image or the hologram image may be less than the fine hologram region depending on the material of the hologram image recording medium or the recording condition.

The performance (pixel pitch) of an image pickup device which captures the reproduced diffraction image from a fine hologram as data determines the level of resolution at which the smearing from the ideal condition of the reproduced diffraction image can be sampled.

In the next step 111, the data of the captured reproduced diffraction image is sent to the diffracted beam intensity computing device 21 of the evaluation value computing device 20, where the captured reproduced diffraction image is converted into intensity distribution data.

In step 112, the process extracts, from the intensity distribution data, an intensity distribution data array fₛ(x, y), which has the same shape and size as those of the fine hologram, to calculate a diffracted beam intensity Iₛ=Σfₛ(x, y) defined by a sum total of the resulting values. Then, in step 113, the maximum value of Iₛ is determined and then output to the area comparator 25 and the switching device 26.

The area comparator 25 compares the area of the reproduced diffraction image captured by the image pickup device with the area of the fine hologram so as to output, to the switching device 26, the signal indicating magnified when the area of the reproduced diffraction image is equal to or greater than the area of the fine hologram or the signal indicating contracted when the reproduced diffraction image is less in area than the fine hologram (see step 114).

In step 115, the switching device 26 sends the output signal from the diffracted beam intensity computing device 21 to the SN ratio computing device 22 when the output signal from the area comparator 25 is the signal indicating magnified, or sends the output signal from the diffracted beam intensity computing device 21 to at least one of the relative diffraction efficiency computing device 23 and the diffraction efficiency computing device 24 in the case of the signal indicating contracted.

In the next steps 116, when the diffracted beam intensity Iₛ takes on the maximum value I_{s (max)}, the noise beam intensity computing device 22A of the SN ratio computing device 22 determines the noise beam intensity Iₙ=Σfₙ(x, y) defined by a sum total of the values of the data array fₙ(x, y), which are a predetermined slice level I_{threshold} or greater, among the data arrays f(x, y) which are not extracted as the fₛ(x, y) (see step 117).

In step 118, on the basis of the output signal from the noise beam intensity computing device 22A, the SN ratio calculator 22B calculates the SN ratio=I_{s (max)}/Iₙ as an evaluation value for the hologram image recording medium.

In step 114, when the area comparator 25 has output the signal indicating contracted, the process proceeds to step 120, whereby the switching device 26 connects the diffracted beam intensity computing device 21 to at least one of the relative diffraction efficiency computing device 23 and the diffraction efficiency computing device 24. In step 121, the relative diffraction efficiency computing device 23 and the diffraction efficiency computing device 24 calculateη₀ and/or η.

Note that when the SN ratio, η₀, and η are determined at the same time and the reproduced diffraction image is less in area than a contracted hologram, the SN ratio is infinite and only the values of η₀ and η are valid, whereas when the SN ratio is a normal value, the values of η₀ and η are invalid.

Note that in an alternative exemplary embodiment without the area comparator 25 and the switching device 26, steps 114 and 115 are eliminated and the process proceeds from step 113 to steps 116 and 121 at the same time.

In the present exemplary embodiment, since a plane wave is used as a signal beam to record the fine hologram, this provides an isotropic interference pattern to be recorded, thus resulting in contraction-induced changes being restrictive. This is because changes of the reproduced diffraction image due to contraction appear mainly as a change in the slope and pitch of the refractive index grid formed in a recording layer, causing almost no changes in the shape and size of the reproduced diffraction image.

Accordingly, in this evaluation apparatus, unlike the case where actual element holograms are recorded, it is desired that the signal beam be not modulated by SLM or condensed with a Fourier transform lens.

Thus, in the exemplary embodiment of the present invention, the SN ratio can be measured with higher accuracy.

As used herein, the term “SN ratio” refers to how much the reproduced diffraction image is deviated from a plane wave being ideally the same in size as the fine hologram, and is used as a performance indicator.

Furthermore, in the aforementioned exemplary embodiment, a plurality of fine holograms are continuously recorded and thereafter reproduced. It is therefore possible to keep track of the following: the recording of undesirable interference pattern components and the dynamic range loss of a recording material, caused by leakage light resulting from the scattering of light inside a recording film or the like upon recording adjacent fine holograms; the dynamic range loss of a recording material due to the fact that the monomer polymerization reaction upon recording adjacent fine holograms reaches the fine hologram region to be measured; and the recording of undesirable interference pattern components due to the multiple reflection of a signal beam and/or a reference beam upon recording adjacent fine holograms.

Note that in the aforementioned exemplary embodiment, the sizes of the reproduced diffraction image and the fine hologram are compared with each other to allow the evaluation value to take on either the SN ratio or the diffraction efficiency (relative diffraction efficiency). However, the present invention can be applied to a method for determining only the SN ratio as an evaluation value and to a method for determining the relative diffraction efficiency and/or the diffraction efficiency.

Furthermore, the aforementioned exemplary embodiment may be configured such that more information on a hologram image recording medium and an optimum recording condition can be obtained not only by reproducing a single fine hologram but also by reproducing a plurality of fine holograms having different recording values and measuring the respective SN ratios. It is thus possible to obtain the following information by comparing the plurality of fine hologram SN ratios.

(1) Information can be obtained, when actual images are recorded, as to how much image qualities are different between the peripheral portion of an image (the portion less affected by an adjacent fine hologram) and the central portion (the portion likely affected by an adjacent fine hologram). It is also possible to determine such a recording condition that reduces variations in image quality between the peripheral portion and the central portion of an image.

(2) Information can be obtained as to how much recording properties vary depending on the in-plane position on the recording medium.

These pieces of information can also be obtained by a conventional static evaluation method. However, it cannot be known how much variations in property determined by the static evaluation method would become evident in an actual holographic printer. Conversely, variations that cannot be detected by the static evaluation method may affect the quality of images provided by the holographic printer. The present invention makes it possible to know such variations or influences.

Note that the pixel pitch “p” of the image pickup device can be reduced to be less than the size “a” of the fine hologram (the length of one side if the fine hologram is a rectangle or the diameter thereof if the fine hologram is a circle) to improve the resolution of the image pickup device. However, to make full use of the SN ratio of the present invention as an evaluation indicator, the pixel pitch “p” is preferably equal to or less than ¼ the size “a” of the fine hologram.

Furthermore, to continuously record element holograms by the holographic printer, multiple recording can be performed so as to prevent the element holograms from overlapping one another or to allow a certain amount of overlap therebetween. In either case, the multiple recording can be performed by the evaluation method of the present invention.

However, since the data that should be extracted as the noise beam intensity Iₙ of an adjacent fine hologram may possibly be included in the diffracted beam intensity Iₛ, the evaluation method of the present invention is preferably applied to non-multiple recording.

### Example Experiment

### Preparing Sample of Hologram Image Recording Medium

Following the procedure below, a recording material composition solution of the composition mentioned below was prepared.

Added to 10 g of vinyl acetate polymer (vinyl acetate polymer manufactured by Wako Pure Chemical Industries Ltd., a number average molecular weight Mn=1400 to 1600, provided as a 50 wt % methanol solution) as a matrix are the following: 3 g of 9,9-bis[4-(2-acryloyloxyethoxy)phenyl]fluorene (NK ester A-BPEF manufactured by Shin-Nakamura Chemical Co., Ltd) as a photo-polymerizable monomer; 1.6 g of diethyl sebacate as a plasticizer; and 2.4 g of a peroxide-based photopolymerization initiator (a 40% anisole solution of a position isomer mixture of BT-2 3,3′-di(tert-butylperoxycarbonyl)-4,4′-di(methoxycarbonyl)benzophenone, etc. manufactured by CHISSO CORPORATION). 6 g of acetone solution (5.99 g of acetone) with 10 mg of a sensitizing dye dissolved therein is added to the mixture and then the mixture was stirred to dissolve the contents. In this manner, the recording material composition solution was obtained.

The resulting recording material composition solution was applied to a PET film with a thickness of 100 μm using a bar coater and dried at room temperatures under a reduced pressure overnight. After having been dried, the recording material layer had a thickness of 20 μm. This was laminated to a slide glass with a thickness of 1.0 mm so that the recording material layer is in contact with the glass surface, and employed as a hologram image recording medium sample.

### (Recording of Fine Holograms)

Using the recording optical system of FIG. 2, fine holograms were continuously recorded onto the hologram image recording medium sample which had been prepared as mentioned above.

In FIG. 2, the incident angle of a reference beam was set to 45 degrees and the incident angle of a signal beam was set to 90 degrees, with the first aperture 42 and the second aperture 56 having a rectangular opening with a side of 500 μm. However, for the reference beam to be a 500 μm×500 μm square on the surface of the medium sample, the length of a side of the first aperture 42 corresponding to the x-axis direction of the medium was defined to be 1/(square root of 2) times 500 μm. Then, with the second shutter 51 opened, the first shutter 33 was opened for a predetermined duration of time to record 500 μm×500 μm fine rectangular holograms. Subsequently, the sample stage was moved by 500 μm (=recording pitch) in the x-axis direction to record fine holograms similarly side by side. In this manner, a plurality of fine holograms were recorded to be adjacent to each other. Finally, 9 fine hologram patterns (=3×3) were recorded. At this time, the recording was performed by opening the first shutter 33 for one second with both the signal beam and the reference beam at an intensity of 5 mW/cm². That is, when each fine hologram was recorded, the accumulated amount of light was 10 mJ/cm². Furthermore, the time pitch was two seconds for recording adjacent fine holograms.

### Reproduction of Fine Holograms

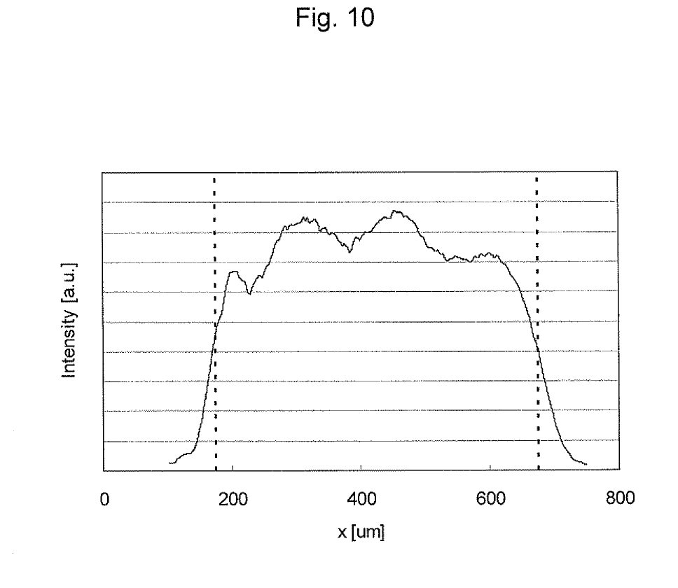

Among the 3×3 adjacent fine hologram patterns recorded as described above, the fine hologram at the center was irradiated with the same reference beam as for the recording to reproduce the fine hologram. That is, in the optical system of FIG. 2, the second shutter 51 was closed and the first shutter 33 was opened, and a CCD was placed as an image pickup device in the direction in which a diffraction image will appear (=the optical system of FIG. 4). However, the intensity of the reference beam was 500 μW/cm². At this time, the reproduced diffraction image was captured by the CCD to acquire the intensity distribution data thereof. Of the intensity distribution data on the xy plane, the intensity distribution along the x-axis for a specific y value is shown in FIG. 10 as an example.

On the basis of the two-dimensional intensity distribution data, the SN ratio and the relative diffraction efficiency were determined (the data actually employed was not the slice data of FIG. 10 but the intensity distribution data across the entire xy plane).

As a result, the SN ratio was found to be 12.3 when the aforementioned hologram image recording medium sample was used to perform recording under the aforementioned recording conditions. Furthermore, the relative diffraction efficiency η₀ was 83%. Note that to calculate the SN ratio, the slice level of the noise component was assumed to be zero.

### REFERENCE SIGNS LIST

10 . . . evaluation apparatus
12 . . . hologram image recording medium
14 . . . recording optical system
16 . . . reading optical system
18 . . . image pickup optical system
19 . . . fine hologram
19A . . . signal beam region
19B . . . smearing region
20 . . . evaluation value computing device
21 . . . diffracted beam intensity computing device
22B . . . SN ratio computing device
22A noise beam intensity computing device
22B SN ratio calculator
23 . . . relative diffraction efficiency computing device
24 . . . diffraction efficiency computing device
25 . . . area comparator
26 . . . switching device
30 . . . light source optical system
31 . . . laser diode
32 . . . polarizing beam splitter
35 . . . first half-wave plate
40 . . . reference beam optical system
50 . . . signal beam optical system

1. A method for evaluating a hologram image recording medium for recording image information by continuously recording element holograms in a two-dimensional manner, the method comprising:
a step of continuously recording a plurality of fine holograms, each being the same in size as the element hologram, on a hologram image recording medium to be evaluated, using either one of a two-beam interference between a reference beam and a signal beam both being a plane wave and a two-beam interference between a reference beam being a plane wave and a signal beam being a spherical wave;
a step of reproducing a diffraction image by irradiating the recorded fine hologram with a plane wave, the plane wave having the same wavelength, the same beam diameter, and the same incident angle as those of one of the reference beam used for recording by the two-beam interference and a conjugate image read beam;
a step of capturing the reproduced diffraction image by an image pickup device which is greater in area than the fine hologram;
a step of converting the captured diffraction image into intensity distribution data to extract an intensity distribution data array fₛ(x, y) which is equivalent in a range of shape and size to the fine hologram on a light-receiving surface of the image pickup device and then calculate a diffracted beam intensity Iₛ=Σfₛ(x, y) defined by a sum total of the extracted intensity distribution data arrays fₛ(x, y);
one of a step of calculating an SN ratio as an evaluation value for the hologram image recording medium, a step of calculating a relative diffraction efficiency η₀ as an evaluation value for the hologram image recording medium, and a step of calculating a diffraction efficiency η as an evaluation value for the hologram image recording medium.

2. The method for evaluating a hologram image recording medium according to claim 1, wherein
when the diffracted beam intensity Iₛ takes on a maximum value I_{s (max)}, the step of calculating an SN ratio determines a noise beam intensity Iₙ=Σfₙ(x, y) defined by a sum total of values of data arrays fₙ(x, y), which take a predetermined slice level I_{threshold} or greater, among data arrays f(x, y) which have not been extracted as the fₛ(x, y), and determines an SN ratio=I_{s (max)}/Iₙ.

3. The method for evaluating a hologram image recording medium according to claim 1, wherein
when the diffracted beam intensity Iₛ takes on the maximum value I_{s (max)}, the step of calculating a relative diffraction efficiency η₀ as an evaluation value for the hologram image recording medium determines η₀=Iₛ/(f_{s (max)} (x, y)×Sₕₒₗₒ/Sₚᵢₓ), where the f_{s (max)} (x, y) is the maximum value of data arrays f(x, y) extracted as the fₛ(x, y), Sₕₒₗₒ is an area of the fine hologram region, and Sₚᵢₓ is a pixel area of the image pickup device.

4. The method for evaluating a hologram image recording medium according to claim 1, wherein
when the diffracted beam intensity Iₛ takes on the maximum value I_{s (max)}), the step of calculating a diffraction efficiency η as an evaluation value for the hologram image recording medium determines η=Iₛ /I_{R}, where I_{R} is an intensity of a plane wave used for reading the fine hologram.

5. The method for evaluating a hologram image recording medium according to claim 1, wherein
the plane wave in the recording step is not modulated.

6. The method for evaluating a hologram image recording medium according to claim 1, wherein
for the plurality of recorded fine holograms, a step of sequentially capturing reproduced diffraction images, a step of extracting an intensity distribution data array fₛ(x, y), and a step of determining an evaluation value are repeated.

7. The method for evaluating a hologram image recording medium according to claim 1, wherein
when a plurality of fine holograms are continuously recorded by two-beam interference on a hologram image recording medium, a size “a” of the fine hologram in a direction of the continuous recording is equal to or less than a pitch “d” of the continuous recording.

8. The method for evaluating a hologram image recording medium according to claim 1, wherein
an image pitch “p” of the image pickup device is equal to or less than ¼ the size “a” of the fine hologram.

9. An apparatus for evaluating a hologram image recording medium for recording image information by continuously recording element holograms in a two-dimensional manner, the apparatus comprising:
a recording optical system for continuously recording a plurality of fine holograms, each being the same in size as the element hologram, on a hologram image recording medium to be evaluated, using either one of a two-beam interference between a reference beam and a signal beam both being a plane wave and a two-beam interference between a reference beam being a plane wave and a signal beam being a spherical wave;
a reading optical system for reproducing a diffraction image by irradiating the recorded fine hologram with a plane wave, the plane wave having the same wavelength, the same beam diameter, and the same incident angle as those of one of the reference beam used for recording by the two-beam interference and a conjugate image read beam;
an image pickup optical system for capturing the reproduced diffraction image on an image pickup device which is greater in area than the fine hologram;
a diffracted beam intensity computing device for converting the captured diffraction image into intensity distribution data to extract an intensity distribution data array fₛ(x, y) which is equivalent in the range of shape and size to the fine hologram on a light-receiving surface of the image pickup device and then calculate a diffracted beam intensity Iₛ=Σfₛ(x, y) defined by a sum total of values thereof;
an SN ratio computing device for determining an SN ratio as an evaluation value for the hologram image recording medium;
a relative diffraction efficiency computing device for determining a relative diffraction efficiency η₀ as an evaluation value for the hologram image recording medium; and
a diffraction efficiency computing device for determining a diffraction efficiency η as an evaluation value for the hologram image recording medium, wherein
the SN ratio computing device has a noise beam intensity computing device for determining a noise beam intensity Iₙ=Σfₙ(x, y) defined by a sum total of values of data arrays fₙ(x, y), which take a predetermined slice level I_{threshold} or greater, among data arrays f(x, y) which have not been extracted as the fₛ(x, y), when the diffracted beam intensity Iₛ takes on a maximum value I_{s (max)}, and an SN ratio calculator for calculating an SN ratio=I_{s (max)}/Iₙ as an evaluation value for the hologram image recording medium,
when the diffracted beam intensity Iₛ takes on the maximum value I_{s (max)}, the relative diffraction efficiency computing device is configured to calculate a relative diffraction efficiency η₀ as an evaluation value for the hologram image recording medium by Equation (1) below
η₀=Iₛ/(f_{s (max)}(x, y)×Sₕₒₗₒ/Sₚᵢₓ) (Equation 1)
where the f_{s (max)} (x, y) is the maximum value of data arrays f(x, y) extracted as the fₛ (x, y), Sₕₒₗₒ is an area of the fine hologram region, and Sₚᵢₓ is a pixel area of the image pickup device, and
when the diffracted beam intensity Iₛ takes on the maximum value I_{s (max)}, the diffraction efficiency computing device is configured to determine the diffraction efficiency η as an evaluation value for the hologram image recording medium by Equation (2) below;
η=Iₛ/I_{R} (Equation 2)
where I_{R} is an intensity of a plane wave used for reading the fine hologram.

10. The apparatus for evaluating a hologram image recording medium according to claim 9, further comprising:
an area comparator for comparing an area of a diffraction image captured by the image pickup device with an area of the fine hologram to output a signal indicating magnified when the area of the diffraction image is equal to or greater than the area of the fine hologram, and output a signal indicating contracted when the area of the diffraction image is less than the area of the fine hologram; and
a switching device for connecting the diffracted beam intensity computing device to the SN ratio computing device when the output signal from the area comparator is the signal indicating magnified, and for connecting the diffracted beam intensity computing device to at least one of the relative diffraction efficiency computing device and the diffraction efficiency computing device when the output signal is the signal indicating contracted.

11. The apparatus for evaluating a hologram image recording medium according to claim 10, wherein
the plane wave in the recording optical system is not modulated.
